(19) United States
(12) Patent Application Publication
(10) Pub. No.: US 2018/0170278 A1
(43) Pub. Date: Jun. 21, 2018

(54) DISPLAY DEVICE FOR ARRANGEMENT ON A MOTOR VEHICLE WINDOW

(71) Applicant: GM GLOBAL TECHNOLOGY OPERATIONS LLC, Detroit, MI (US)

(72) Inventors: Volker Carneiro, Ruesselsheim (DE); Reiner Geib, Mainz-Kostheim (DE)

(73) Assignee: GM GLOBAL TECHNOLOGY OPERATIONS LLC, Detroit, MI (US)

(21) Appl. No.: 15/849,169

(22) Filed: Dec. 20, 2017

(30) Foreign Application Priority Data
Dec. 20, 2016 (DE) 10 2016 015 114.5

(51) Int. Cl. B60R 11/02; B60K 35/00

(52) U.S. Cl. CPC B60R 11/0229; B60K 35/00

(57) ABSTRACT

A display device is disclosed for arrangement on a window of a motor vehicle. The display device includes a carrier with a flat rear side having at least one splice configured to be attached the carrier to the window. A first induction element is arranged on the carrier and configured to be connected in an electrically conductive manner with an electronic display arranged on the carrier. The first induction element may be inductively coupled with a second induction element connected by a cable with the electrical system of the motor vehicle.

### CROSS-REFERENCE TO RELATED APPLICATION

This application claims priority to German Patent Application No. 102016015114.5, filed Dec. 20, 2016, which is incorporated herein by reference in its entirety.

### TECHNICAL FIELD

This present disclosure pertains to a display device for arrangement on a motor vehicle window. In addition, it relates to a vehicle window as well as to a motor vehicle equipped with such a window and/or display device.

### BACKGROUND

Display devices for arrangement in the interior of a motor vehicle are generally known in prior art for providing information to the driver of a motor vehicle. For example, a display device with a display panel having active optical elements for image generation is disclosed in DE 102 38 531 A1. The active optical element is arranged in the vehicle in such a way that the driver can use the display to view the road or control elements in the vehicle.

For example, the display device can here be arranged on the instrument panel in an area above the center console in front of the windshield. For example, a plug connection can be provided to supply power to a display panel, which can be configured as a plug of a cigarette lighter in the center console of the motor vehicle.

In order to keep the visual field of the driver or vehicle passengers as unimpaired as possible, it is advantageous to arrange such display devices in an edge area of the visual field of the driver. However, such edge areas are comparatively difficult to access from the standpoint of installation. In addition, there is the problem of energy supply or signal connection for the display.

### SUMMARY

In accordance with the present disclosure, an improved display device is provided for arrangement in the interior of a motor vehicle, which enables a particularly easy, space-saving and production-efficient assembly. The display device and its fastening concept are especially easy to integrate into an extensively automated production process. The display device as described herein provides a low weight and comparatively low manufacturing and assembly costs.

In particular, a display device is provided for arrangement on a window of a motor vehicle. The display device includes a carrier with a flat rear side. The rear side has at least one splice for attachment to the window of the motor vehicle. The display device further includes a first induction element arranged on the carrier, which can be connected in an electrically conductive manner with an electronic display configured to be arranged on the carrier. The first induction element arranged on the carrier provides a power supply for the electronic display of the display device. The electronic display may include at least one electrically actuatable lamp, such as an electrically operable light source, for example a light-emitting diode (LED). The first induction element may be operatively connected with a counter- or second induction element arranged on the vehicle side.

The electronic display may be supplied with electrical energy via the inductive coupling of the first and second induction elements, without the display device having to be hard-wired with the motor vehicle or motor vehicle electrical system for this purpose. The inductive coupling and inductive electrical energy supply for the display device enables a particularly easy and production-efficient arrangement of the display device in locations that can only be accessed with difficulty in the process of assembling the motor vehicle. The inductive coupling between the first and second induction elements eliminates the need for manufacturing a plug connection in such inaccessible areas of the motor vehicle or motor vehicle body.

The inductive coupling of the display device with the second induction element arranged on the body side further enables a preassembly of the display device on built-in components of the motor vehicle, for example on a window of the motor vehicle before the latter is mounted on or in the motor vehicle. During final assembly, the display device prefixed on the motor vehicle component is finally moved into an end assembly position, in which the induction element arranged thereon inductively interacts with the second induction element provided on the body side so as to transmit energy.

In an embodiment of the display device, the first induction element is arranged on a front side of the carrier. The first induction element and splice are thus located on opposite sides of the carrier. Arranging the first induction element on the front side enables an arrangement or alignment of the first induction element facing away from the splice and window. In this way, the latter can be situated immediately adjacent to the second induction element provided on the body side.

In another embodiment, the electronic display is arranged on a first end section of the carrier. By contrast, the first induction element is arranged on a second end section lying opposite the first end section. The carrier can have an elongated geometry. The electronic display is arranged on the first longitudinal end of the carrier. The first induction element is arranged on the second longitudinal end of the carrier. As a consequence, the first induction element and electronic display are arranged on opposing longitudinal ends of the carrier. IN this configuration, the electronic display may be arranged in the viewing field or edge area of a visual field of the driver, while the first induction element is located outside the visual field or outside the visual field edge area.

In another embodiment, a fastening element is provided on the first end section for detachably fastening the electronic display to the carrier. Providing a fastening element makes it possible to replaceably arrange the electronic display on the carrier. Should the electronic display at some point be defective or if it is to be replaced by another electronic display, this can be done at any time using the carrier-side fastening element. By contrast, the carrier can be permanently and non-detachably bonded to the window.

In another embodiment, an electronic display may be either detachably arranged or non-detachably arranged on the carrier. The detachable arrangement of the electronic display is possible in combination with the fastening element provided on the first end section. Another embodiment in which the electronic display is non-detachably arranged on the carrier also makes do without a fastening element. The term “non-detachably” is to be interpreted as not nondestructively detachable in the present conjunction.

Another embodiment provides that the electronic display have a board with at least one light source. In particular a light-emitting diode (LED) is possible as the light source. The board can also be fitted with several light sources, in particular with several LEDs. It is conceivable that the display have several light sources arranged equidistantly to each other at a prescribed distance from each other.

For example, a series of 3, 4 or more light sources may be provided. A two-dimensional arrangement is also possible, i.e., an array of light sources on the board. In particular, the electronic display can serve as a distance warning system relative to other vehicles or obstacles located in the surrounding area of the motor vehicles. In this regards, the motor vehicle can be equipped with a distance warning system consisting of radar or ultrasound sensors. The latter can be used to determine a distance from a vehicle ahead or a fixed obstacle. If the determined distance measures below a prescribed minimum, the onboard electronics of the motor vehicle can activate the electronic display, and thereby warn the driver of imminent danger.

In another embodiment, the board has at least one counter-fastening element, the design of which corresponds to the fastening element of the carrier. The interaction between the counter-fastening element and fastening element makes it possible to detachably arrange the board, and hence detachably arrange the entire electronic display, on the carrier of the display device.

In another exemplary embodiment, a housing enclosing the electronic display and having a transparent window covering the electronic display may be arranged on the carrier. Detachably arranging the housing on the carrier makes it possible to change out the electronic display located therein or covered by the latter without having to remove the carrier from the window for this purpose. In particular, the transparent pane can be configured like a spreading window, so that the light generated by the light source of the display can be radiated into the motor vehicle interior without any glare.

In another embodiment, the electronic display can be electrically connected with the first induction element by an electrical conductor arranged on the carrier in the form of a flat cable or in the form of a conducting path. In particular, the display device has an integrated electrical conductor. The latter is fixedly arranged on the carrier, for example on the front side of the carrier. The electrical conductor can be used to transmit or conduct electrical energy from the induction element to the electronic display. The electrical conductor can also be configured as an electrical signal connection between the electrical system of the motor vehicle and the electronic display.

In the connection area for the electronic display, in particular in the area of the fastening element, a plug connection can be provided between the electrical conductor and the electronic display. A plug connection makes it possible to change out the electronic display as needed.

Another aspect provides for a vehicle window. The vehicle window has an inner side and typically also an outer side. With the window installed in the motor vehicle, the inner side of the window adjoins the vehicle interior. A display device described above is bonded to the inner side of the vehicle window. In particular, it is provided that the display device may be bonded to the window before the window is installed on or in the motor vehicle. In this way, there is advantageously no need to separately install the display device during the final assembly process of the motor vehicle.

In another embodiment, the window has a window edge area, which is provided at least sectionally or completely with a window black print. In particular, the window black print may extend over the entire edge area of the window. In the area of the window black print, the window rests on a window carrier provided on a motor vehicle or body side.

In another embodiment, the display device is arranged in the area of the window black print or in a transitional area from the window black print to a transparent window area adjacent thereto. The longitudinal extension of the display device, and consequently of its carrier, may be directed roughly perpendicular to the window edge. It is here provided in particular that the second end section of the carrier be directed toward the window edge and that the first end section of the carrier be directed away from the window edge. The second end section of the carrier may have a greater distance from the window edge than the first end section of the carrier. The induction element may be arranged in the area of the window black print, and thus not visible from outside. The electronic display can be arranged in a transitional region from the black print into the transparent window area, or extend at least partially into the transparent window area.

In another aspect, a motor vehicle is further provided with a vehicle body and a vehicle interior. An interior trim is arranged in the interior. The motor vehicle is further equipped with a display device, which is situated adjacent to the interior trim and was described above. It is typically bonded to an inner side of a window of the motor vehicle. Additionally or alternatively thereto, the vehicle can also be provided with a vehicle window of the kind described above.

In particular, the vehicle window may be configured as a windshield. The display device is arranged in particular in a mount or base region of the windshield, adjacent to an instrument panel. In this embodiment, the interior trim has at least one instrument panel. Due to the adhesively bonded arrangement of the display device in or on the lower edge area of the windshield, the induction element can be located behind or below the instrument panel, while the electronic display visibly protrudes at least slightly from the instrument panel.

In another embodiment, the motor vehicle has a second induction element arranged on the motor vehicle body. With the display device installed on or in the motor vehicle, the display device is arranged on the window in such a way that the induction element interacts inductively with the second induction element arranged on the vehicle side. The inductive interaction between the first and second induction elements provides a current and voltage supply, and thus an electrical energy supply, as well as an electrical signal connection for the display device.

The second induction element may be fastened in or on the body in white at any time before installing the window. The display device can be bonded to the window typically provided by a motor vehicle supplier prior to window assembly. Once the window has been installed on the vehicle, the induction element of the display device moves into an operating area of the second induction element, so that a wireless electrical and signal-transmitting connection can be established between it and the motor vehicle electrical system.

In another embodiment, the second induction element is arranged below the interior trim or an instrument panel. In particular, the second induction element can be arranged in a gap between a window support and an instrument panel in the interior of the motor vehicle. After the window has been installed, in particular the windshield, this area can be largely inaccessible.

### BRIEF DESCRIPTION OF THE DRAWINGS

The present disclosure will hereinafter be described in conjunction with the following drawing figures, wherein like numerals denote like elements.

FIG. 1 is a schematic view of a motor vehicle;

FIG. 2 is a cross section through a base area of the windshield with a display device arranged thereon;

FIG. 3 is a top view of a window edge area with a display device arranged thereon;

FIG. 4 is a cross section taken through line A-A shown in FIG. 3;

FIG. 5 is a cross section taken through line B-B shown in FIG. 3; and

FIG. 6 is a cross section taken through line C-C shown in FIG. 3.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

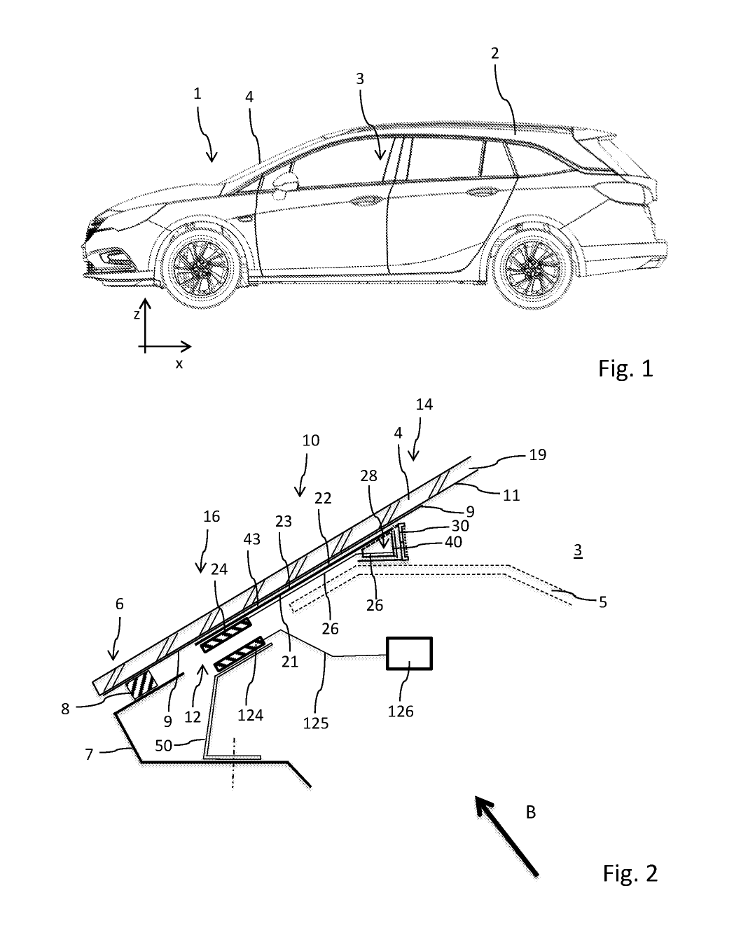

FIG. 1 illustrates a side view of a motor vehicle in the form a passenger car. The motor vehicle 1 has a motor vehicle body 2 with an interior 3 that serving as a passenger compartment. The interior 3 is bordered by a glass panel forming a windshield 4 toward the front, when viewed in the traveling direction of the motor vehicle 1. An instrument panel 5 schematically depicted in FIG. 2 and/or a corresponding motor vehicle interior trim 5 is located below the windshield 4 in the interior 3, particularly below a mount or base area of the windshield.

With a gasket 8, the window 4 rests on a window support 7 of the motor vehicle body 2 that acts as a cross member. A holder 50 is arranged on the window support 7. In the illustrated embodiment, the window support 7 has a roughly U- or C-shaped geometry. The holder 50 is provided with a second induction element 124 on an end section facing away from the window support 7. This is located in a gap 12 between the lower front end of the instrument panel 5 and an upper end of the window support 7. With the window 4 installed, this gap 12 is largely inaccessible.

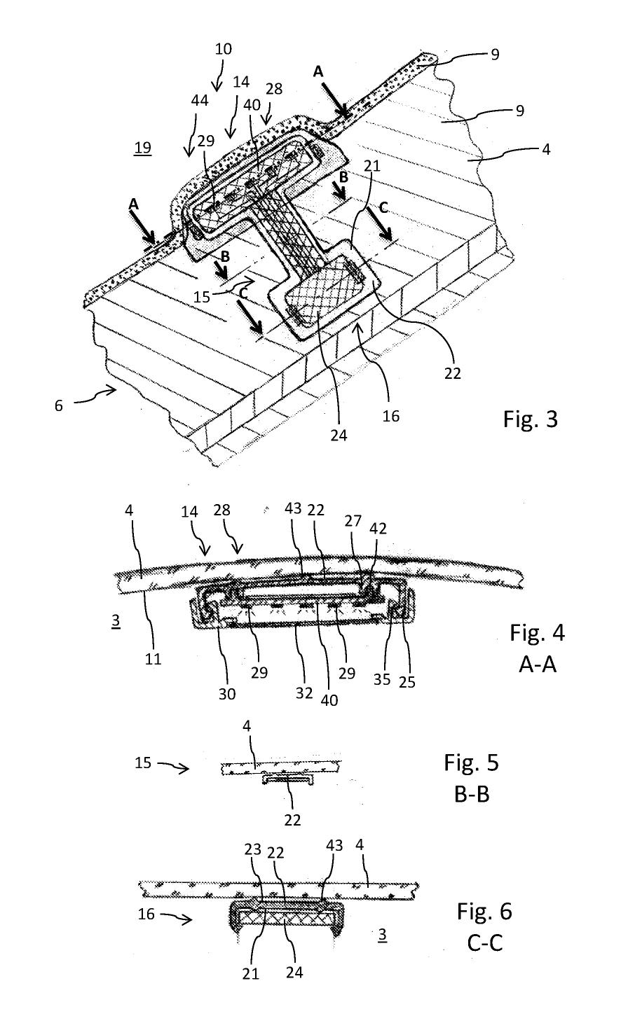

A display device 10 shown in cross section in FIG. 2 and from above in FIG. 3 is arranged on an inner side 11 of the window 4. The display device 10 has a carrier 22 with a largely flat and even configuration. A rear side 23 of the carrier 22 is provided with at least one splice 43. The rear side 23 of the carrier 22 can also be completely provided with one or several splices 43, or be coated by an adhesive layer configured to fasten the carrier 22 of the display device 10 on the inner side 11 of the window 4.

A first induction element 24 is arranged on a front side 21 facing away from the rear side 23, and in the finally assembled configuration shown in FIG. 2 comes to lie in the operating area of the second induction element 124. As depicted in FIG. 2, the first induction element 24 and second induction element 124 align with each other extensively in terms of area. The elements 24, 124 are arranged in the direction of the surface normal of the window 4 at a prescribed distance from each other. The operating area of the first and second induction elements 24, 124 further enables an electrical connection that compensates for installation tolerances. The precise position of the first induction element 24 relative to the second induction element 124 can vary within prescribed tolerances, which are significantly larger than the installation tolerances to be observed for the window 4 relative to the motor vehicle body 2.

The first induction element 24 may be inductively coupled with the second induction element 124. The second induction element 124 is connected by a cable 125 with the electrical system 126 of the motor vehicle 1, and hence also with a motor vehicle control device.

At least one electrical conductor 26 is arranged on the front side 21 of the carrier 22. The first induction element 24 is located on a second end section 16 of the elongated carrier 22. An electronic display 28 is arranged on an opposing first end section 14 of the carrier 22. The electronic display 28 is connected with the first induction element 24 in an electrically conductive manner by the electrical conductor 26. Finally, the electronic display 28 is connected with the electrical system 126 of the motor vehicle 1 via the inductive coupling of the first induction element 24 and second induction element 124.

In the present exemplary embodiment, the electronic display 28 includes a board 40 with several light sources 29 arranged thereon. The individual light sources 29 are shown in particular in FIG. 3 and FIG. 4. Involved in the present case are individual LEDs, which are arranged uniformly spaced apart along a line on the board 40. The board 40 may be detachably arranged on the carrier 22 by a counter-fastening element 42. To this end, the carrier 22 may have at least one fastening element 27, which is configured correspondingly to the counter-fastening element 42 of the board 40. The fastening element 27 and counter-fastening element 42 can include a latching or snap connection, and consequently a positive connection.

The board 40 may be connected via a plug connection with the electrical conductor 26, which is fixedly arranged on the carrier 22 as a flat cable or conducting path. This enables a replaceable arrangement of the electronic display 28, and thus of board 40, on the carrier 22. The electronic display 28 may further be provided with a housing 30. The housing 30 may cover the entire electronic display or entire board 40 and all light sources 29 arranged herein, and protect them against environmental influences.

As shown in FIG. 4, the housing 30 may be provided with a transparent window 32, so that the light that can be generated by the light sources 29 is able to exit the housing 30 through the window and radiate into the interior 3. In particular, the window 32 may be configured as a diffuser, so that the individual point light sources 29 cannot be separately perceived by the passengers.

As also shown in FIG. 4, the housing 30 may have a connecting element 35, which can interact with a carrier-side connecting element 25. The two connecting elements 25 and 35 may be correspondingly configured relative to each other in such a way as to yield a snap or latching connection. The connecting elements 25, 35 may be configured as corresponding intermeshing latching tabs or snap hooks. This permits a removable arrangement of the housing 30 on the carrier 22.

As depicted in FIG. 3, the carrier 22, and thus the entire display device 10, has a T-shaped or double-T-shaped basic geometry. The illustration in FIG. 3 presents a top view of the display device 10 in viewing direction B, as denoted in FIG. 2 with an arrow. The first end section 14 can be spread out perpendicular to the longitudinal direction of the carrier 22, so that the individual light sources 29 are spaced apart from each other roughly along the progression of the window edge 6. Provided between the first and second end sections 14, 16 is an intermediate section 15 with a tapered design. The intermediate section 15 is configured to establish a mechanical connection between the first and second end sections 14, 16, as well as to guide or fasten the electrical conductor structure 26, which extends from the second end section 16 toward the first end section 14.

As further evident from a combined review of FIGS. 3-6, nearly the entire display device 10 is arranged in the area of a window edge 6. The window edge 6 is provided with a window black print 9 sketched in FIG. 3. The electronic display 28 of the display device 10 is arranged in the transitional area to a transparent window area 19 spaced apart from the window edge 6. The first induction element 24 and second end section 16 of the carrier 22 are located completely in the area of the wiper black print 9. As further illustrated in FIG. 3, the transitional area between the window black print 9 and transparent window area 19 is provided with a bulge 44 toward the transparent window area 19. The first end section 14 of the display device 10 and the electronic display 28 come to lie in the area of this bulge 44 or formation.

As depicted in FIG. 2 in particular, the electronic display 28 is thus located above the instrument panel 5, so that the light that can be generated by the electronic display 28 or a corresponding visual warning signal can be readily and unimpededly perceived by the vehicle passengers.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-15. (canceled)

16. A display device for arrangement on a window of a motor vehicle comprising:
a carrier having a flat rear side with at least one splice configured to attached on the window;
a first induction element arranged on the carrier; and
an electronic display supported on the carrier and electrically connected in with the first induction element.

17. The display device according to claim 16, wherein the induction element is arranged on a front side of the carrier.

18. The display device according to claim 17, wherein the electronic display is arranged on a first end section of the carrier, and wherein the induction element is arranged on a second end section opposite the first end section.

19. The display device according to claim 18, further comprising a fastening element disposed on the first end section for detachably fastening the electronic display to the carrier.

20. The display device according to claim 19, wherein the electronic display comprises a counter-fastening element detachably engaging the fastening element.

21. The display device according to claim 16, wherein the electronic display comprises a board with at least one light source.

22. The display device according to claim 21 further comprising a first fastening element disposed on a first end section of the carrier and a second fastening element disposed on the board and configured to detachably engage the first fastening element.

23. The display device according to claim 16, further comprising a housing enclosing the electronic display and a transparent window covering the electronic display arranged on the carrier.

24. The display device according to claim 23, further comprising an electrical conductor arranged on the carrier and configured electrically connecting the induction element and the electronic display.

25. The display device according to claim 23, wherein the electrical conductor comprises a flat cable.

26. A vehicle windshield assembly comprising:
a glass panel having an inner surface configured to adjoin a vehicle interior when installed in the motor vehicle; and
a display device including a carrier having a flat rear side with at least one splice bonded on the inner side of the glass panel, a first induction element arranged on the carrier, and an electronic display supported on the carrier and electrically connected with the first induction element.

27. The vehicle window according to claim 26, wherein the glass panel comprises a window edge area including an area proximate the display device having a window black print.

28. A motor vehicle comprising a motor vehicle body defining a vehicle interior having an interior trim arranged therein, and a vehicle windshield according to claim 26 bordering the vehicle interior, wherein the display device is situated adjacent to the interior trim.

29. The motor vehicle according to claim 28, further comprises a second induction element arranged on the motor vehicle body such that the first induction element inductively interacts with the second induction element.

30. The motor vehicle according to claim 29, wherein the second induction element is arranged below the interior trim.

31. The motor vehicle according to claim 29, wherein the second induction element is arranged in a gap between a window support of the motor vehicle body and the interior trim.
